(19) United States
(12) Patent Application Publication
(10) Pub. No.: US 2007/0134439 A1
(43) Pub. Date: Jun. 14, 2007

(54) Liquid crystal display panel having a conductive polymer

(76) Inventor: Chun-Yi Huang, Padeh City (TW)

Correspondence Address: RABIN & Berdo, PC, 1101 14TH STREET, NW, SUITE 500, WASHINGTON, DC, 20005, US

(21) Appl. No.: 11/299,910

(22) Filed: Dec. 13, 2005

(51) Int. Cl. C09K 19/00

(52) U.S. Cl. 428/1.1

(57) ABSTRACT

A liquid crystal display (LCD) panel having a conductive polymer is described. On an upper surface and a lower surface of the LCD panel, a first conductive polymer and a second conductive polymer are coated so that charges accumulated on the LCD panel when the polarizer and the LCD panel are bonded together, where a release film of the polarizer is torn off, may be eliminated.

### BACKGROUND OF THE INVENTION

1. Field of the Invention

The present invention relates to a liquid crystal display (LCD) panel having a conductive film and particularly to an LCD panel having a conductive polymer coated thereon so that damage caused by charges on thin film transistor (TFT) devices or integrated circuits (ICs) in the LCD panel may be eliminated.

2. Descriptions of the Related Art

Currently, liquid crystal displays (LCDs) have been widely used in replace of cathode ray tubes (CRTs) in various electronic products. For example, the LCDs have been employed for displaying information in laptops, mobile phones and the like. The liquid crystal (LC) is used for displaying information by means of its bi-refractive characteristic which controls a polarization state of a light source. Generally, each LCD comprises a polarizer as shown in FIG. 1. In forming such polarizer, a polyvinyl alcohol (PVA) Film+I2/Dye layer 7 is first prepared by adding iodine crystal or dye into PVA. Then, a transparent substrate made of triacetyl cellulose (TAC) 5, 9 is stuck onto two sides of the PVA Film+I2/Dye layer 7 for protection and shrinkage prevention of the layer 7. Then, a layer of pressure sensitive adhesive (PSA) 3 is added onto the transparent substrate 5 to provide the polarizer with environmental impact bearing, wear-resisting and chemical erosion-resisting abilities. Finally, a surface protection layer 10 (not shown) and a release film 1 are formed on an outmost layer of the substrate so that the substrate may be bonded to a glass. Since a typical polarizer is made of an insulative material, a huge amount of charges is apt to be accumulated instantaneously. The huge amount of charges may cause damage on thin film transistor (TFT) devices or integrated circuits (ICs) in the LCD panel when the polarizer is bonded onto the LCD panel.

To resolve this problem, a discharge polarizer is suggested as shown in FIG. 2. In the discharge polarizer, a discharge polarizing layer 6 is coated on the polarizer, the polarizing layer 6 being blended with metallic particles, such as aluminum film and metallic oxide, so as to provide an ability of electrostatic conduction. On an upper surface and a lower surface of the discharge polarizing layer 6, an anti-reflective layer 8 and an adhesion layer 4 are provided, respectively. Under the adhesion layer 4, a release film 2 is formed. Although the discharge polarizer may reduce the accumulated charges to 0.2 KV, cost thereof is relatively increased for manufacturing and rework therefor is relatively difficult.

### SUMMARY OF THE INVENTION

In view of the above-mentioned drawbacks encountered in the prior art, it is an object of the present invention to provide a liquid crystal display (LCD) panel having a conducting film used to prevent thin film transistor (TFT) devices or integrated circuits (ICs) in the LCD panel from damaged caused by charges.

It is another object of the present invention to provide a method of forming a conducting film on an LCD panel through which TFT devices or ICs in the LCD panel may be prevented from damage caused by charges

To achieve the above objects, the LCD panel having a conducting film according to the present invention comprises a LCD panel, a first conducting high polymer film disposed on an upper surface of the LCD panel and a second conducting high polymer film disposed on a lower surface of the LCD panel, wherein the conductive polymers are capable of eliminating charges and thus protecting the LCD panel.

The method of manufacturing an LCD panel having a conducting film comprises the steps of: providing an LCD panel, coating a first conducting high polymer film on an upper surface of the LCD panel and coating a second conducting high polymer film on a lower surface of the LCD panel.

With the provision of the LCD panel having the conducting film and the manufacturing thereof, the problem of the accumulated charges and thus the damage caused by the charges when the polarizer and the LCD panel are bonded together, where a release film is torn off from the polarizer is improved with a simple and convenient manufacturing process but without the need of a complex design.

### BRIEF DESCRIPTION OF THE DRAWINGS

The invention will become more fully understood from the detailed description given hereinbelow illustration only, and thus are not limitative of the present invention, and wherein:

FIG. 1 is a schematic diagram of a sectional view of a conventional polarizer of liquid crystal display (LCD);

FIG. 2 is a schematic diagram of a sectional view of a discharge charges polarizer of LCD;

FIG. 3 is a schematic diagram of an LCD having a conducting film according to a first embodiment of the present invention;

FIG. 4 is a schematic diagram of the LCD having a conducting film according to a second embodiment of the present invention;

FIG. 5 is a schematic diagram of the LCD having a conducting film according to a third embodiment of the present invention; and

FIG. 6 is a flowchart illustrating a method of manufacturing the LCD having the conducting film according to the present invention.

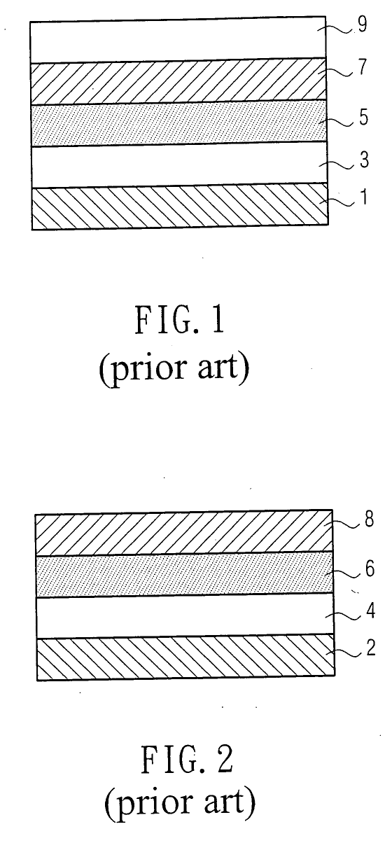

### DETAILED DESCRIPTION OF THE INVENTION

To enable the objects, features and advantages of the present invention to be readily understood, the present invention will be described in more detail via the preferred embodiments with reference to the accompanying drawings.

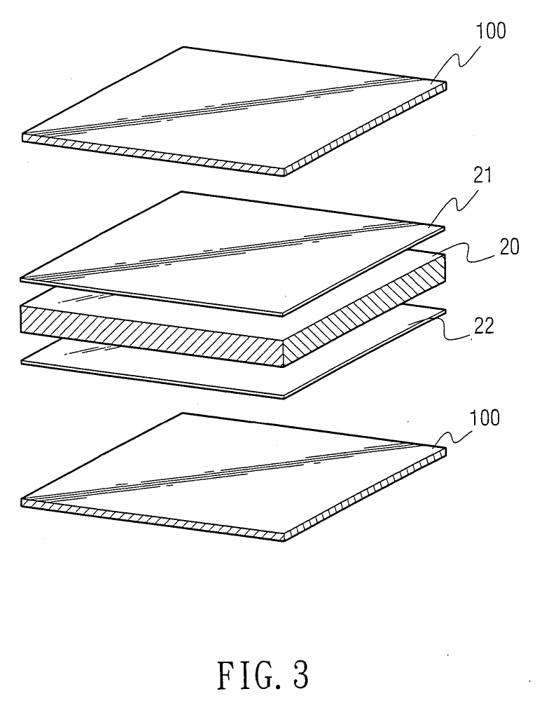

Referring to FIG. 3, an LCD having a conducting film according to a first embodiment of the present invention is depicted therein. An LCD panel 20 comprises a first conducting high polymer film 21 formed on an upper surface of the LCD panel 20 and a second conducting high polymer film 22 formed on a lower surface of the LCD panel 20. The first and the second conducting high polymer films 21, 22 are each formed by spin-coating a solution of PAPSA (poly (aniline-co-N-(4-sulfophenyl) aniline)) copolymer, having a suitable concentration, with water as a solvent or other organic solvents, wherein the first and the second conducting high polymer films 21, 22 each have a conductivity of 0.0035 S/cm per unit area. Then, an upper polarizer 100 and a lower polarizer 100 are then bonded onto the upper and lower conducting high polymer films 21, 22 respectively. As such, charges produced when the polarizers 100 are bonded to the panel 20 is apt to be rapidly eliminated through the first and the second conducting high polymer films 21, 22, and thus ICs and TFT devices in the panel is exempted from damage.

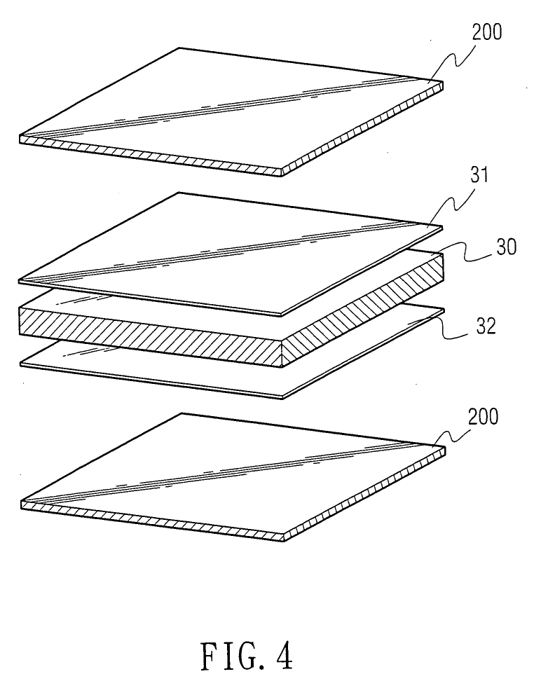

Referring to FIG. 4, an LCD having a conducting film according to a second embodiment of the present invention is depicted therein. An LCD panel 30 comprises a first conducting high polymer film 31 formed on an upper surface of the LCD panel 30 and a second conducting high polymer film 32 formed on a lower surface of the LCD panel 30. The first and the second conductive high polymers 31, 32 are each formed by spin-coating a solution of a PSA (poly (N-(4-sulfophenyl) aniline)), having a suitable concentration, with water as a solvent or other organic solvents, wherein the first and the second conducting high polymer film 31, 32 each have a conductivity of 0.006 S/cm per unit area. Then, an upper polarizer 200 and a lower polarizer 200 are bonded onto the first and the second conducting high polymer films 31, 32, respectively. As such, charges produced when the polarizers 200 are bonded to the panel 30 is apt to be rapidly eliminated through the first and the second conducting high polymer films 31, 32, and thus ICs and TFT devices in the panel is exempted from damage.

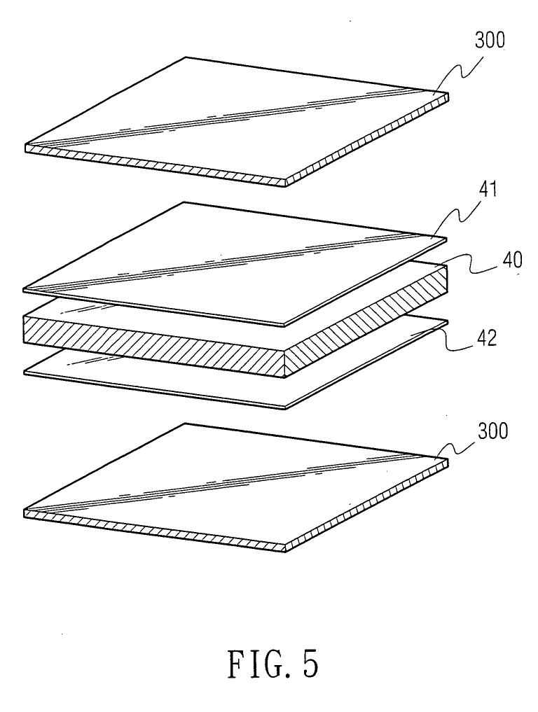

Referring to FIG. 5, an LCD having a conducting film according to a third embodiment of the present invention is depicted therein. An LCD 40 comprises a first conducting high polymer film 41 formed on an upper surface of the LCD panel 40 and a second conducting high polymer film 42 formed on a lower surface of the LCD panel 40. The first and the second conducting high polymer films 41, 42 are each formed by spin-coating a solution of PAPSAH (poly (aniline-co-N-propanesulfonic acid aniline)), having a suitable concentration, with water as a solvent or other organic solvents, wherein the first and the second conductive high polymers 41, 42 each has a conductivity of 0.01 S/cm per unit area. Then, an upper polarizer 300 and a lower polarizer 300 are bonded onto the first and second conductive high polymers 41, 42, respectively. As such, charges produced when the polarizers 300 are bonded to the panel 40 is apt to be rapidly eliminated through the first and the second conductive high polymers 41, 42, and thus ICs and TFT devices in the panel is exempted from damage.

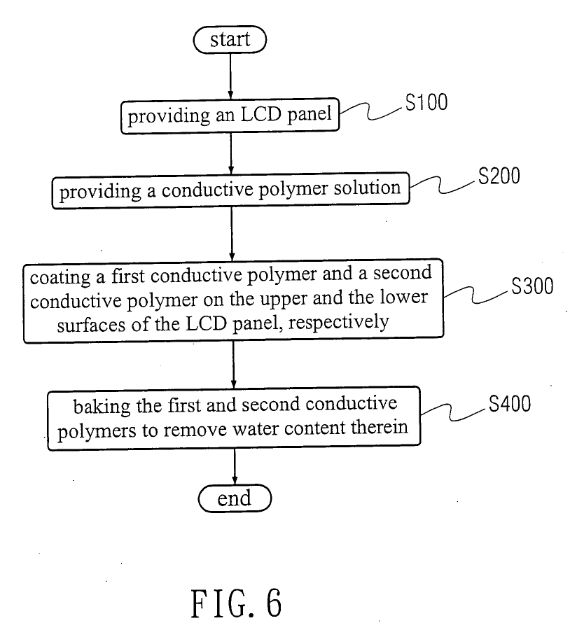

Referring to FIG. 6, a flowchart illustrating a method of manufacturing an LCD panel having a conductive polymer is depicted therein. The method comprises the following steps. At first, an LCD panel is provided (Step 100). Then, a conductive polymer solution capable of eliminating charges is prepared, the solution being formed by using conductive polymer powder dissolved in water or other organic solvents (Step 200). Next, the conductive polymer solution is coated on an upper surface as a first conductive polymer and a lower surface as a second conductive polymer of the LCD panel by a spin-coating method (Step 300). Thereafter, the conductive polymer solution on the LCD panel is to bake at a temperature of 100° C. After the water content in the solution is removed, the conductive film in a form of the conductive polymers is obtained (Step 400).

Since the conductive polymer provides a specific conductivity, the accumulated charge on the surface of the polarizer occurred when the polarizer is bonded to the LCD panel may be conducted away or rapidly eliminated through the conductive polymers. As such, the TFT devices and ICs in the LCD panel may be exempted from damage. Further, the conductivity of each of the conductive polymers may be high up to 0.01 S/cm, near to those of conductors. In addition, the conductive polymer is slight in weight and easy to be processed.

In conclusion, since the accumulated charges produced when the polarizer is bonded onto the panel may be eliminated by the inventive conductive polymer formed on the LCD panel, the pricy discharge polarizer may not be necessary and thus cost of the LCD panel may be reduced.

While embodiments and applications of this invention have been shown and described, it would be apparent to those skilled in the art having the benefit of this disclosure that many more modifications than mentioned above are possible without departing from the inventive concepts herein. The invention, therefore, is not to be restricted except in the spirit of the appended claims and their equivalents.

What is claimed is:

1. A liquid crystal display (LCD) panel having a conductive polymer, comprising:
an LCD panel;
a first conductive polymer disposed on an upper surface of said LCD panel; and
a second conductive polymer disposed on a lower surface of said LCD panel.

2. The LCD panel as claimed in claim 1, wherein the material of said first conductive polymer or said second conductive polymer is selected from the group consisting of PAPSA (poly (aniline-co-N-(4-sulfophenyl) aniline)), PSA (poly (N-(4-sulfophenyl) aniline)) and PAPSAH (poly (N-(4-sulfophenyl) aniline)) copolymer, respectively.

3. The LCD panel as claimed in claim 1, wherein said first and second conductive polymers each have a conductivity of between 0.0035 S/cm and 0.01 S/cm per unit area.

4. A method of manufacturing an LCD panel having a conductive polymer, comprising the steps of:
providing an LCD panel;
providing a conductive polymer solution; and
coating a first conductive polymer and a second conductive polymer on the upper and lower surfaces of said LCD panel, respectively.

5. The method as claimed in claim 4, wherein the material of said first conductive polymer or said second conductive polymer is selected from the group consisting of PAPSA (poly (aniline-co-N-(4-sulfophenyl) aniline)), PSA (poly (N-(4-sulfophenyl) aniline)) and PAPSAH (poly (N-(4-sulfophenyl) aniline)) copolymer, respectively.

6. The method as claimed in claim 4, wherein said conductive polymer solution is prepared to have a specific concentration by solving a conductive polymer powder into water or other organic solvents.

7. The method as claimed in claim 4, wherein said first and second conductive polymers are coated on said upper and lower surfaces of said LCD respectively by a spin-coating method.

8. The method as claimed in claim 4, further comprising, after said step of coating, a step of baking at a temperature of 100° C. said first and second conductive polymers to remove water content therein.
